(19) United States
(12) Patent Application Publication
(10) Pub. No.: US 2007/0017453 A1
(43) Pub. Date: Jan. 25, 2007

(54) Animal litter containing activated carbon

(76) Inventors: Charles F. Fritter, Pleasanton, CA (US); Dennis B. Jenkins, Pleasanton, CA (US)

Correspondence Address: THE CLOROX COMPANY, P.O. BOX 24305, OAKLAND, CA, 94623-1305, US

(21) Appl. No.: 11/189,182

(22) Filed: Jul. 25, 2005

(51) Int. Cl. A01K 1/015

(52) U.S. Cl. 119/173

(57) ABSTRACT

Disclosed herein is the use of activated carbon in amounts as low as 0.03% by wt. to control odor combined with a color-masking agent in traditional litter compositions. Powdered activated carbon (PAC) having a mean particle diameter less than 500 μm is preferred. The color-masking agent and activated carbon can be incorporated into the litter composition by dry blending, agglomeration or spray coating.

### FIELD OF THE INVENTION

The present invention relates generally to absorbent litter materials for pets. More particularly, the present invention relates to absorbent materials that contain an effective odor-controlling amount of activated carbon and a color-masking agent to aid with disguising the black color of the carbon.

### DESCRIPTION OF RELATED ART

Domestic, housebroken animal, particularly cats, are typically trained to urinate and defecate in a specially provided litter box. Consequently, pet owners, homeowners, veterinarians and laboratory personnel have added absorbent materials to the litter box to collect the urine and feces (i.e., animal dross). A major problem with the absorbent materials is that after a relatively short period of time, the dross soiled absorbent emits objectionable odors due to the presence of the animal dross.

The most commonly used absorbent materials are inexpensive clays, such as calcined clays, that are safe and non-irritating to the animals. As is well known in the art, clays generally absorb relatively substantial amounts of liquids.

Other absorbent materials that are used alone, in combination, or in combination with clay include straw, sawdust, wood chips, wood shavings, porous polymeric beads, shredded paper, bark, cloth, ground corn husks, cellulose, water-insoluble inorganic salts, such as calcium sulfate, silica gel and sand.

Litter compositions having bentonite clay particles have been employed. Bentonite is a water-swellable clay which upon contact with liquid (or moist) dross, readily agglomerates with other moistened bentonite clay particles. The moist animal waste is thus isolated by the agglomeration of the moist clay particles and can be readily removed from the litter. Illustrative bentonite based litter compositions are

disclosed in U.S. Pat. Nos. 5,503,111; 5,386,803; 5,317,990; 5,129,365 and RE 33,983, which are hereby incorporated by reference in their entirety.

Additives, such as starch or sugar based binders can be added to non-bentonite clays to create a litter material that behaves like a bentonite clay, i.e., upon contact with liquid (or moist) dross, readily agglomerates with other moistened clay particles. U.S. Pat. No. 5,359,961 discloses a clumping non-swelling clay based litter and is hereby incorporated by reference in its entirety.

Activated carbon or charcoal is known to absorb odors. Litter compositions containing activated carbon are disclosed in, for example, U.S. Pat. Nos. 5,860,391 and 6,287,550 and in U.S. Pat. App. Pub. Nos. 2005/0005869 and 2005/0056229, which are hereby incorporated by reference in their entirety. Clay has very poor odor-controlling qualities, and inevitably waste build-up leads to severe malodor production. One attempted solution to the malodor problem has been the introduction of granular activated carbon (GAC) (20-8 mesh) into the litter. However, the GAC is usually dry blended with the litter, making the litter undesirably dusty. Because the clay and GAC particles are merely mixed, the litter likely will have GAC in high concentrations in some areas, and low concentrations to no GAC in others. Additionally, activated carbon or charcoal is black in color. Aside from being aesthetically unpleasing to the consumer in the box, the black color from the GAC particles can also be tracked out of the box into the home by the animal.

Thus, a need exists to provide an odor-controlling absorbent material that is both effective and aesthetically pleasing to the consumer.

### SUMMARY OF THE INVENTION

An aspect of the invention includes an animal litter comprising an absorbent material suitable for use as an animal litter; activated carbon in an amount effective for controlling odor in the animal litter; and a color-masking agent to mask the black color of the carbon.

Another aspect of the invention includes a method for forming a plurality of

animal litter particles comprising the steps of combining (1) particles of an absorbent material suitable for use as an animal litter with (2) particles of activated carbon in an amount effective for controlling odor in the animal litter and (3) a color-masking agent to mask the black color of the activated carbon.

### DETAILED DESCRIPTION

Before describing the present invention in detail, it is to be understood that this invention is not limited to particularly exemplified systems or process parameters as such may, of course, vary. It is also to be understood that the terminology used herein is for the purpose of describing particular embodiments of the invention only, and is not intended to limit the scope of the invention in any manner. As is generally accepted by those of ordinary skill in the animal litter art, the following terms have the following meanings. The terms scoopable and clumping litter as used herein refer to a litter that agglomerates upon wetting such that the soiled portion can be removed from the litter box leaving the unsoiled portion available for reuse. The term non-clumping or poorly clumping as used herein refers to a litter material doesn't agglomerate upon wetting to the extent that the soiled portion could be easily removed from the litter box. As will be discussed in further detail below, additives may be added to a non-clumping or poorly clumping litter substrate to create clumping behavior.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “color masking agent” includes two or more such agents.

Unless defined otherwise, all technical and scientific terms used herein have the same meaning as commonly understood by one of ordinary skill in the art to

which the invention pertains. Although a number of methods and materials similar or equivalent to those described herein can be used in the practice of the present invention, the preferred materials and methods are described herein.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. All numerical values, however, inherently contain certain errors necessarily resulting from the standard deviation found in their respective testing measurements.

The following description includes embodiments presently contemplated for carrying out the present invention. This description is made for the purpose of illustrating the general principles of the present invention and is not meant to limit the inventive concepts claimed herein.

Disclosed herein is the use of activated carbon and a color-masking agent combined with one or more absorbent materials suitable for use as an animal litter. Powdered activated carbon (PAC) is particularly desirable for use in animal litter because it gives much greater surface area than granular activated carbon (GAC) which is typically ≧35 mesh U.S. Standard Sieve (U.S.S.S.), and thus PAC has more sites with which to trap odor-causing materials and is therefore more effective at lower concentration levels. When blended with an absorbent material, PAC will tend to segregate out of during shipping, thereby creating excessive dust (also known as “sifting”). By agglomerating PAC into particles or fixing PAC onto absorbent particles with a fixing agent, the present invention overcomes problems encountered with carbon settling out during shipping. PAC as used herein is defined as carbon particles having a mean particle diameter less than 500 μm. The preferred particle size of the PAC is about 150 microns (˜100 mesh U.S.S.S.) or less, and ideally in the range of about 25 to 150 microns, with a mean diameter of about 50 microns (˜325 mesh U.S.S.S.) or less. The activated carbon reduces odor levels in cat litter through absorption of volatile odors in the gas phase. The combination of absorbent material and PAC can be combined with a wide variety of other materials including antimicrobial agents, fixing agents, binding agents, litter filler materials, supplemental absorbent materials, fragrances and additional odor-controlling agents. By supplemental absorbent material is meant a swelling or non-swelling absorbent material that is present in a weight percent less than the weight percent of the primary absorbent material as based on the total weight of the litter composition.

The black color of the carbon can be masked by a variety of methods. As used herein, the term “mask” as it is used in relation to activated carbon refers to the lightening, changing and/or hiding of the black color of the carbon by the use of a color-masking agent. For example, a the black color of the carbon particles become less apparent by dilution effects (i.e., because of the surrounding environment, the black color of the carbon is less apparent), whitening of the particles (e.g., lightening the black to a whitish or grayish color), or creating a colored particle where the black is completely or partially hidden under the color (e.g., green, blue, etc . . . ) thereby lessening its visibility. Combinations of various methods including those listed above can also be used to effectively mask the black color of the carbon.

The activated carbon can be encapsulated with a starch encapsulate, or mixed with a color-masking agent and then blended with the primary absorbent material. Color-masking agent as used herein means any material which by itself or in combination with another material lightens and/or hides (including by dilution effects) the black color of the carbon. Examples of color-masking agents include whitening compounds such as titanium dioxide (rutile or anatase), zinc oxide, calcium oxide, magnesium oxide, magnesium carbonate, aluminum oxide, calcium carbonate, dolomite, chalk, talc, white sand dust, and kaolin; and coloring compounds such as organic pigments, inorganic pigments, organic dyes, and colored inorganic minerals. Typically if one or more coloring compounds are used, they are used in conjunction with one or more whitening compounds, i.e., generally the whitening and coloring compounds are first blended together prior to mixing with the carbon and/or absorbent material.

A variety of processing techniques can be utilized to blend the primary absorbent material, the activated carbon and the color-masking agent including dry blending, agglomeration, and spray coating. For example, the activated carbon along with one or more color-masking agents can be dry added to the primary absorbent material. The carbon can be coated onto a substrate and sprayed with a fixing solution (e.g., fibrillated Teflon or Xanthan gum dissolved in water) to fix the carbon in place. Alternatively, functionalized speckles can be created by blending one or more whitening compounds and optionally one or more coloring compounds with activated carbon particles and then spraying the mixture onto the absorbent material. The result is a plurality of partially or substantially coated whitened or colored absorbent particles containing odor-controlling activated carbon spread throughout the litter composition. Often, as mentioned, a fixing agent is added to the spraying solution to “fix” the lightened carbon particles onto the absorbent substrate. In another embodiment, the absorbent material, activated carbon and color-masking agent(s) can be agglomerated with a substrate to form a carbon-functionalized agglomerate speckle which can then be dry blended with the primary absorbent material. A carbon-functionalized speckle can also be formed by agglomerating the carbon with an absorbent material and then spray coating the agglomerate with a color-masking agent. Suitable agglomeration techniques are discussed in pending U.S. patent application Ser. No. 10/618,401 filed Jul. 11, 2003 and Ser. No. 11/119,204 filed Apr. 29, 2005, which are hereby incorporated by reference in their entirety. Processes for color-masking of activated carbon are disclosed in U.S. Pat. No. 5,407,442 to Karapasha and U.S. Pat. No. 6,740,406 to Hu et al., which are hereby incorporated by reference in their entirety.

The amount of activated carbon that will be effective at odor control will vary depending on the form the activated carbon is in. For example, GAC has been observed to be effective at providing some odor-controlling benefits in concentrations as low as 0.3 weight percent based on the total weight of the litter composition whereas PAC has been observed to be effective at providing some odor-controlling benefits in concentrations as low as 0.03 weight percent based on the total weight of the litter composition. It is anticipated that some other forms of carbon as discussed below can be effective at even lower concentrations.

The color-masking agent if added to the entire litter composition generally comprises up to approximately 5% of the litter composition, and typically comprises approximately 0.001%-0.1% of the litter composition. In one embodiment where the color-masking agent is incorporated into the spray coating, the coating is disposed on at least 1% of the primary absorbent material. In one embodiment titanium dioxide is present in an amount ranging from 0.01-10 weight percent based on the total weight of the animal litter.

As used herein activated carbon means absorbent carbon-based materials, including activated and reactivated carbon based absorbents. Activated carbon, including the material commonly called activated charcoal, is an amorphous form of carbon characterized by high adsorptivity for many gases, vapors and colloidal solids. Carbon is generally obtained by the destructive distillation of coal, wood, nut-shells, animal bones or other carbonaceous materials, including coconuts. The carbon is typically “activated” or reactivated by heating to about 800.degree.-900.degree. C. with steam or carbon dioxide, which results in a porous internal structure. The internal surfaces of activated carbon typically average about 10,000 square feet per gram. Surface area in absorptive carbons is typically measured by a test called BET-Nitrogen, and measures the extent of the pore surfaces within the matrix of the activated carbon. BET-Nitrogen is used as a primary indicator of the activity level of the carbon, based on the principle that the greater the surface area, the higher the number of adsorptive sites available. It is believed that carbons having a BET number greater than 500 will provide odor control equivalent to PAC at concentration levels equal to or less than those disclosed herein as effective for PAC.

Many liquid-absorbing materials may be used without departing from the spirit and scope of the present invention. A key component of the litter compositions of the invention is the primary absorbent material which also can comprise a combination of two or more materials. Illustrative primary absorbent materials include but are not limited to absorbent and semi-absorbent clays, absorbent rocks, and some natural and synthetic minerals. Absorbent and semi-absorbent clays include “swelling” clays such as sodium smectite, sodium montmorillonite (aka sodium bentonite), beidellite, and hectorite and non-swelling clays such as calcium smectite, calcium montmorillonite (aka calcium bentonite), attapulgite (aka palygorskite), sepiolite, natural zeolite, synthetic zeolite, kaolinite, tobermorite, vermiculite, halloysite, illite, and mica. Geographic terms used to describe illustrative clay materials include Wyoming Bentonite, Georgia White Clay, Fuller's Earth, and Monterey Shale. Absorbent rocks include perlite, volcanic ash, expanded perlite, pumice, diatomite (aka diatomaceous earth), tuff, opaline silica, slate, marls, and fossilized plant material. Suitable natural minerals include opal (aka amorphous silica), silica, quartz (aka sand), calcite, dolomite, gypsum, bassenite (aka plaster of Paris), aragonite, and feldspar. Suitable synthetic minerals include dicalcium silicate and amorphous silicas (e.g., silica gel, precipitated silica, fumed silica, silica aerogel) and aluminas (e.g., amorphous alumina, activated alumina, activated bauxite, gibbsite, bauxite, boehmite, pseudoboehmite).

Other compounds such as antimicrobial agents, fragrances, fixing agents, binding agents, litter filler materials, supplemental absorbent materials, supplemental deodorants, dust controlling agents, release agents, health indicating agents, and mixtures and combinations thereof can be added to the primary components of the litter material. These additional compounds can added at any time. For example, they may be added to the primary absorbent or agglomerates thereof, sprayed on during a spray-coating step, or dry blended with the litter composition.

Fragrance

The litter compositions can additionally include one or more fragrances to provide a freshness or deodorizing impression to humans or serve as an attractant fragrance to animals. Although some “free” fragrance can be present, it is preferable that at least a major part of the fragrance (or perfume) be contained or encapsulated in a carrier to prevent premature loss to the atmosphere, as well as to avoid a strong fragrance odor which can be uncomfortable to the animals. The encapsulation can be in the form of molecular encapsulation, such as the inclusion complex with cyclodextrin, coacevate microencapsulation wherein the fragrance droplet is enclosed in a solid wall material, or “cellular matrix” encapsulation wherein solid particles containing perfume droplets are stably held in the cells. Fragrance can also be more crudely embedded in a matrix, such as a starch or sugar matrix.

The encapsulated fragrance can be released either by a moisture activation and/or a pressure activation mechanism. Moisture-activated microcapsules release fragrance upon being wetted, e.g., by the animal urine. Pressure-activated microcapsules release fragrance when the shell wall is broken, e.g., by the scratching or stepping of the animals on the litter. Some microcapsules can be activated both by moisture and pressure.

The animal litter of the present invention can also contain pro-fragrances. A pro-fragrance is a normally nonvolatile molecule which consists of a volatile fragrance ingredient covalently bonded to another moiety by a labile covalent bond. In use, the pro-fragrance is decomposed to release the volatile fragrance ingredient. Preferred pro-fragrances include complexes of bisulfite, with fragrance ingredients having aldehyde or ketone functional groups, and esters of phosphoric acids, and sulfuric acids with fragrance ingredients having a hydroxyl group.

The fragrance may comprise approximately 0.001%-1%, by weight, of the litter composition, and typically comprises approximately approximately 0.01%-0.2%, by weight, of the litter composition.

Binding Agent

A binding agent may be used to cause a non-clumping or poorly clumping clay material to clump when wetted. Preferably, the binding agent or agents include (i) natural polymers and synthetic derivatives thereof, including, but not limited to, lignins, gums, starches and polysaccharides, such as lignin sulfonate, carboxymethylcellulose, hydroxyethylcellulose, hydroxypropylcellulose, ethylhydroxyethyl cellulose, methylhydroxypropylcellulose, guar gum, alginates, starch, xanthan gum, gum acacia, and gum Arabic, (ii) synthetic polymers, including, but not limited to, polyvinylpyrrolidone, polyethylene glycol, polyethyleneoxide, acrylate polymers and copolymers, acrylic emulsions, polyvinyl alcohol, polyvinyl acetate, polyvinyl pyrrolidine, polyacrylic acid, latexes (e.g., neoprene latex), superabsorbent polymers (e.g., cross-linked polyacrylates), flocculating agents (e.g., polycarboxylates), and fluorinated polymers (e.g., polytetrafluoroethylene and fibrillated Teflon) and (iii) inorganic agglomerating agents, including, but not limited to, soluble silicates and phosphates, including pyrophosphates and aluminates.

In one embodiment of the invention, the binding agent comprises a polysaccharide gum, e.g., a galactomannan gum. As is well known in the art, a galactomannan gum is a carbohydrate polymer containing D-galactose and D-mannose units, or other derivatives of such a polymer. Galactomannan gums include guar gum, which is the pulverized endosperm of the seed of either of two leguminous plants (Cyamposis tetragonalobus and psoraloids), locust bean gum, which is found in the endosperm of the seeds of the carob tree (Ceratonia siliqua), and carob gum. In another embodiment the binding agent comprises a Xanthan gum dissolved in water or a cellulose ester. A preferred cellulose ester is commercially available under the trade name METHOCEL™.

Generally, the binding agent(s) comprises approximately 0.01%-40% of the litter composition and typically, the binding agent(s) comprises approximately 5%-20% of the litter composition.

Fixing Agent

As indicated above, the litter compositions of the invention may also include at least one fixing agent to keep the activated carbon and the color-masking agent adhered to a substrate. The fixing agent or agents include (i) natural polymers and synthetic derivatives thereof, including, but not limited to, lignins, gums, starches and polysaccharides, such as lignin sulfonate, carboxymethylcellulose, hydroxyethylcellulose, hydroxypropylcellulose, ethylhydroxyethyl cellulose, methylhydroxypropylcellulose, guar gum, alginates, starch, xanthan gum, gum acacia, and gum Arabic, (ii) synthetic polymers, including, but not limited to, polyvinylpyrrolidone, polyethylene glycol, polyethyleneoxide, acrylate polymers and copolymers, acrylic emulsions, polyvinyl alcohol, polyvinyl acetate, polyvinyl pyrrolidine, polyacrylic acid, latexes (e.g., neoprene latex), superabsorbent polymers (e.g., cross-linked polyacrylates), flocculating agents (e.g., polycarboxylates), and fluorinated polymers (e.g., polytetrafluoroethylene), fibrillated Teflon, and (iii) inorganic agglomerating agents, including, but not limited to, soluble silicates and phosphates, including pyrophosphates and aluminates. Acrylic polymers or co-polymers from Rhodia, BASF and other emulsion polymer vendors may be used.

The amount of the fixing agent present in the litter composition varies. The fixing agent is water-soluble and comprises up to approximately 6%, by weight, of the litter composition. Typically, the fixing agent comprises less than approximately 2%, by weight, of the litter composition.

Dust Controlling Agent

In a further embodiment, suitable fixing agents which also serve to control dust include, but are not limited to fluorinated polymers such as Teflon and tacky acrylic polymers such as those sold as Rhodopas® or Rhoplex®.

Release Agent

Release agents comprise compounds that inhibit the binding of the litter clump to the litter box.

Anti-Bacterial Agent

Embodiments of the litter compositions of the invention can further include at least one anti-bacterial agent (or antimicrobial and/or urease inhibitor) as an odor control agent. Actives of these types may work by preventing the causes of the odor, such as inhibiting the bacteria that create the odors. One class of anti-bacterial or odor control agents is water soluble transition metal ions and their soluble salts such as silver, copper, zinc, iron, and aluminum salts and mixtures thereof. Examples of metallic salts include zinc chloride, zinc gluconate, zinc lactate, zinc maleate, zinc salicylate, zinc sulfate, zinc ricinoleate, copper chloride, copper gluconate, and mixtures thereof. Preferred transition metals include silver, copper, zinc, ferric and aluminum salts.

Other odor control anti-bacterial agents include sulfuric acid, phosphoric acid, hydroxamic acid, thiourea, iodophores, 3-isothiazolones, salts of phytic acid, plant extracts, pine oil, naturally occurring acids and antimicrobials, such as quaternary ammonium compounds, organic sulfur compounds, halogenated phenols, hexachlorophene, 2,4,4′-trichloro-2′-hydroxydiphenyl ether, trichlorocarbanalide, 2,4-dichloro-meta-xylenol, 3,4,5-tribromosalicylanalide, 3,5,3′, 4′-tetrachlorosalicylanalide, and mixtures thereof. Some of these odor control anti-bacterial agents can be added to litters to function as bacteriostats, ie., they are present in relatively low amounts to ensure lack of or minimalodor by transiently present bacteria which may act on the unused litter ingredients to produce off-odors or signal to the consumer that the product is “not fresh.” Some of the preferred bacteriostats include a number of materials produced by Rohm and Haas under the brand name Kathon.

A particularly effective class of bacteriostats are boron compounds, including borax pentahydrate, borax decahydrate and boric acid. Polyborate, tetraboric acid, sodium metaborate and other forms of boron are also appropriate alternative materials. Other boron-based compounds potentially suitable for use are disclosed in Kirk-Othmer, Encyclopedia of Chemical Technology, 3^{rd} Ed., Vol. 4, pp. 67-109 (1978), which is incorporated by reference herein. Effective borax compounds are disclosed in U.S. Pat. No. 5,992,351, which is incorporated herein by reference in its entirety.

Applicants have found that borax provides multiple benefits in odor control by: (1) acting as a urease inhibitor, which controls odors by preventing enzymatic breakdown of urea; and (2) exhibiting bacteriostatic properties, which appear to help control odor by controlling the growth of bacteria which are responsible for production of the urease enzymes. Applicants have further found that an odor controlling effective amount comprises at least about 0.02% equivalent boron, more preferably, greater than 0.03% equivalent boron.

In some embodiments, the anti-bacterial agent comprises approximately 0.02%-1%, by weight, of the litter composition and typically the anti-bacterial agent comprises approximately 0.02%-0.15%, by weight, of the litter composition. As will be appreciated by one skilled in the art, the compositional levels can be adjusted to ensure effective odor control and cost effectiveness.

Odor Controlling Agent

In a further aspect of the invention, the litter composition includes one or more odor controlling agents in the form of odor absorbing agents which provide an odor control benefit by preventing the odors from being detected, such as absorbing, encasing, or neutralizing the odor. Compounds that absorb primary amines are particularly desirable. Other odor control actives include nanoparticles that may be composed of many different materials such as carbon, metals, metal halides or oxides, or other materials. Additional types of odor absorbing/inhibiting actives include fragrant oils, carbonates, bicarbonates, kieselguhr, chelating agents, chitin and pH buffered materials, such as carboxylic acids and the like, cyclodextrin, zeolites, silicas, acidic salt-forming materials, and mixtures thereof. Activated alumina (Al₂O₃) has been found to provide odor control comparable and even superior to other odor control additives. Alumina is a white granular material, and is properly called aluminum oxide.

In a further aspect of the invention, enzymes are employed as odor control agents. The enzymes include ureases and proteases, such as pepsin, tripsin, ficin, bromelin, papain, rennin, and mixtures thereof.

Litter Filler Materials

Because minerals, and particularly clays, are heavy, it may be desirable to reduce the weight of the absorbent particles to reduce shipping costs, reduce the amount of material needed to need to fill the same relative volume of the litter box, and to make the material easier for customers to carry. Filler materials may be added to reduce the overall weight and or cost of the litter material. Illustrative filler materials include limestone, sand, calcite, dolomite, recycled waste materials, zeolites, perlite, expanded perlite, vermiculite, expanded vermiculite, diatomaceous earth and gypsum. These filler materials can be incorporated with the absorbent materials to reduce the cost of the litter without significantly decreasing the material's performance as a litter.

### EXAMPLE

A non-agglomerated, non-clumping litter sample containing carbon-functionalized speckles wherein about 5 grams of slurry is placed on about 75 grams of Georgia White Clay (GWC) is prepared as follows: A slurry is prepared containing approximately 8% PAC, 72% deionized water (carrier), 14% titanium dioxide (whitening compound), 5% ultra marine blue (coloring pigment) and 0.5% Rhodopas® (binding agent). The slurry is dripped onto GWC at an approximate 12% loading capacity and is allowed to dry in air. The dried colored GWC is then blended in a 50:50 ratio with GWC to get approximately a litter sample having approximately 0.5% PAC. Alternatively, the slurry is sprayed onto the complete batch of GWC and either air-dried or oven-dried. Effective color-masking of the carbon was observed in both cases. Scale-up of this formulation wherein the slurry is sprayed onto the clay will result in a method for preparing a litter containing carbon-functionalized speckles.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

We claim:

1. An animal litter comprising:
an absorbent material suitable for use as an animal litter;
activated carbon in an amount effective for controlling odor in said animal litter; and
a color-masking agent to mask the black color of the carbon.

2. The animal litter recited in claim 1, wherein the color-masking agent is selected from the group consisting of a whitening compound, an organic pigment, an inorganic pigment, an organic dye, an inorganic mineral and mixtures thereof.

3. The animal litter recited in claim 1 wherein the color-masking agent is rutile titanium dioxide, anatase titanium dioxide or a mixture of rutile and anatase titanium dioxide.

4. The animal litter recited in claim 1 wherein the color-masking agent is present in an amount ranging from 0.01-10 weight percent based on the total weight of the animal litter.

5. The animal litter recited in claim 1 wherein the absorbent material and activated carbon are formed into an absorbent material/carbon mixture and at least partially coated with the color-masking agent.

6. The animal litter recited in claim 1 wherein the activated carbon, the color-masking agent and a portion of the absorbent material are agglomerated and then blended with the remaining portion of the absorbent material to form an animal litter having functionalized odor-controlling speckles.

7. The animal litter recited in claim 2 wherein the whitening compound is selected from the group consisting of rutile titanium dioxide, anatase titanium dioxide, zinc oxide, calcium oxide, magnesium oxide, magnesium carbonate, dolomite, chalk, talc, aluminum oxide, white sand dust, calcium carbonate, kaolin and mixtures thereof.

8. The animal litter recited in claim 1 wherein the activated carbon is powdered activated carbon having a mean particle diameter less than 500 μm.

9. The animal litter recited in claim 1 wherein the activated carbon is granular activated carbon.

10. The animal litter recited in claim 8 wherein the effective amount of activated carbon is at least 0.03 weight percent of the litter composition.

11. The animal litter recited in claim 9 wherein the effective amount of activated carbon is at least 0.3 weight percent of the litter composition.

12. The animal litter recited in claim 1 further comprising at least one of an antimicrobial agent, a fragrance, a fixing agent, a binding agent, a litter filler material, a supplemental absorbent material, a supplemental deodorant, a dust controlling agent, a release agent, and a health indicating agent.

13. The animal litter recited in claim 12 wherein the antimicrobial agent is selected from the group consisting of transition metal ions, sulfuric acid, phosphoric acid, hydroxamic acid, thiourea, iodophores, 3-isothiazolones, salts of phytic acid, plant extracts, pine oil, quaternary ammonium compounds, organic sulfur compounds, halogenated phenols, hexachlorophene, 2,4,4′-trichloro-2′-hydroxydiphenyl ether, trichlorocarbanalide, 2,4-dichloro-meta-xylenol, 3,4,5-tribromosalicylanalide, 3,5,3′, 4′-tetrachlorosalicylanalide, cyclodextrins, chelating agents, chitin, boron compounds and mixtures thereof; the fragrance is selected from the group consisting of oil-based fragrances, molecularly encapsulated fragrances, cellular matrix encapsulated fragrances, pro-fragrances and mixtures thereof; the fixing agent is selected from the group consisting of starch, mucilage, fluoropolymer emulsions, water soluble acrylic polymers, soluble vinyl polymers, and mixtures thereof; the binding agent is selected from the group consisting of natural polymers and synthetic derivatives thereof, synthetic polymers, inorganic agglomerating agents and mixtures thereof; the litter filler material is selected from the group consisting of limestone, sand, calcite, perlite, expanded perlite, vermiculite, expanded vermiculite, dolomite, recycled waste materials, zeolites, gypsum and mixtures thereof; the supplemental absorbent material is selected from the group consisting of sodium smectite, sodium montmorillonite, beidellite, hectorite, calcium smectite, perlite, volcanic ash, expanded perlite, pumice, diatomite, tuff, opaline silica, slate, marls, fossilized plant material, opal, silica, quartz, calcite, dolomite, gypsum, bassenite, aragonite, feldspar, dicalcium silicate, silica gel, precipitated silica, fumed silica, silica aerogel, amorphous alumina, activated alumina, activated bauxite, gibbsite, bauxite, boehmite, pseudoboehmite and mixtures thereof; and the supplemental deodorant is selected from the group consisting of water soluble metal salts, activated alumina, cyclodextrin, zeolites, silicas, acidic salt-forming materials and mixtures thereof.

14. The animal litter recited in claim 1 wherein the absorbent material is a non-swelling clay selected from the group consisting of calcium montmorillonite, attapulgite, sepiolite, natural zeolite, synthetic zeolite, kaolinite, tobermorite, vermiculite, halloysite, illite, mica, shale, Wyoming Bentonite, Georgia White Clay, Fuller's Earth, Monterey Shale and mixtures thereof.

15. The animal litter recited in claim 1 wherein the absorbent material is a swelling clay selected from the group consisting of sodium bentonite, hectorite, beidellite, and mixtures thereof.

16. The animal litter recited in claim 1 wherein the absorbent material is a combination of non-swelling and swelling clays.

17. A method for forming an animal litter comprising:
combining a plurality of carbon-functionalized speckles with an absorbent material suitable for use as an animal litter and optionally at least one of an antimicrobial agent, a fragrance, a fixing agent, a binding agent, a litter filler material, a supplemental absorbent material, a supplemental deodorant, a dust controlling agent, a release agent, and a health indicating agent wherein the carbon-functionalized speckles comprise an absorbent material suitable for use as an animal litter, activated carbon and a color-masking agent to mask the black color of the carbon.

18. The method for forming an animal litter recited in claim 17 wherein the carbon-functionalized speckles are formed by the process selected from the group consisting of (1) agglomerating particles of an absorbent material suitable for use as an animal litter, particles of activated carbon and at least one color-masking agent; (2) agglomerating particles of absorbent material suitable for use as an animal litter and particles of activated carbon and then spray-coating with the color-masking agent; (3) combining the activated carbon particles with the color-masking agent and optionally a fixing agent and sprayed-coating the carbon/color-masking mixture onto the absorbent material so that the absorbent material is at least partially coated with the sprayed-on solution.

19. A method for forming a carbon-functionalized speckle comprising:
combining an absorbent material suitable for use as an animal litter, activated carbon, and a color-masking agent.

20. The method for forming a carbon-functionalized speckle recited in claim 19 wherein the step of combining is accomplished by a process selected from the group consisting of (1) agglomerating particles of an absorbent material suitable for use as an animal litter, particles of activated carbon and at least one color-masking agent; (2) agglomerating particles of absorbent material suitable for use as an animal litter and particles of activated carbon and then spray-coating the agglomerate with the color-masking agent; (3) mixing the activated carbon particles with the color-masking agent and optionally a fixing agent and sprayed-coating the carbon/color-masking mixture onto the absorbent material so that the absorbent material is at least partially coated with the sprayed-on solution.
